(19) United States
(12) Patent Application Publication
(10) Pub. No.: US 2004/0058297 A1
(43) Pub. Date: Mar. 25, 2004

(54) Root canal instrument

(76) Inventor: Karl-Heinz Danger, Detmold (DE)

Correspondence Address: PEARNE & GORDON LLP, 1801 EAST 9TH STREET, SUITE 1200, CLEVELAND, OH, 44114-3108, US

(21) Appl. No.: 10/621,499

(22) Filed: Jul. 17, 2003

(30) Foreign Application Priority Data
Jul. 20, 2002 (DE) 102 33 030.1

(51) Int. Cl. A61C 5/02

(52) U.S. Cl. 433/102

(57) ABSTRACT

The present invention relates to a root canal instrument for manual use, the instrument comprising a grip member 1 which has attached thereto an elongated tapering shaft 2 which is provided with at least one cutting edge coiled in spiral form around the longitudinal axis 8 of the shaft 2, characterized in that the shaft 2 has a cross-sectional shape which is provided at two opposite sides with one cutting edge 3, 4 each and whose side surfaces 5, 6 connecting the cutting edges 3, 4 are each made convex.

### DESCRIPTION

The present invention relates to a root canal instrument for manual use according to the preamble of the main claim.

In detail, the present invention relates to a root canal instrument for manual use, the instrument comprising a grip member which has attached thereto an elongated tapering shaft. This shaft is provided with at least one cutting edge coiled in spiral form around the longitudinal axis of the shaft.

In contrast to root canal instruments conceived for processing by machine, root canal instruments for manual use are normally equipped with a shaft that is conical or tapering in a similar way and has formed thereon one or several cutting edges that are substantially spiral. The prior art shows numerous design variants in this respect. Reference is just made by way of example to EP 1 108 395 A2. A similar root canal instrument is shown in EP 019 356 B1.

Each of the known root canal instruments is provided with a square, triangular or rhombic cross-section. A square cross-section yields a total of four cutting edges whereas a triangular cross-section only comprises three cutting edges. In the case of rhombic cross-sections two of the corners or edges recede from the turning circle, so that only two opposite cutting edges are formed.

Such root canal instruments are also standardized according to ISO 6360. The respective work lengths and the corresponding diameters are also standardized.

It is the object of the invention to provide a root canal instrument of the above-mentioned type which, being easily producible at low costs, shows good mechanical properties and a high cutting performance.

According to the invention this object is achieved by the features of the main claim; the subclaims show further advantageous designs of the invention.

Hence, according to the invention the shaft has a cross-sectional shape which is provided at two opposite sides with one cutting edge each and whose side surfaces connecting the cutting edges are each made convex.

The root canal instrument according to the invention is characterized by a number of advantages.

Thanks to the cross-sectional shape chosen according to the invention, which can also be designated as a cross section in the form of a bird's tongue or as a lenticular cross-section, there are only two side surfaces to be machined, namely the two side surfaces that are made convex and connect the cutting edges. In comparison with rhombic cross-sectional shapes, the machining efforts are thereby reduced quite considerably.

Furthermore, the cross-sectional shape of the invention shows a high degree of stability, so that the root canal instrument can be subjected to high mechanical loads without the risk of failure.

According to a further advantageous development the cutting edge is made symmetrical relative to a straight line or plane connecting the two cutting edges. Since the shaft with the cutting edges is coiled or spiral, it goes without saying that strictly speaking no central plane can be defined. Hence, the symmetry referred to regards the respective cutting plane of the root canal instrument in which the two cutting edges are connected by a straight line. The above-described symmetrical design of the cutting edges has the advantage that the cutting edges in both rotational directions have the same good cutting properties because there are the same working angles of the cutting edge.

It has been found to be particularly advantageous when the two cutting edges of the root canal instrument are made identical.

The tangent angles at the cutting edges may range between 70° and 110°. The tangent angles are dependent on the working part length of the root canal instrument and the respective diameter.

According to the invention the two side surfaces are preferably curved in the form of an arc. It may be advantageous to provide a curvature in the form of a circular arc. However, any other geometrical curvature, e.g. an elliptical curvature, is possible.

Furthermore, it is advantageous when the two side surfaces are made symmetrical relative to the straight line or plane connecting the cutting edges. This yields the same moments of resistance in both rotational directions, so that the mechanical loadability of the root canal instrument is the same for both rotational directions.

To avoid any jamming in the root canal of a tooth, it may be advantageous when the front portion of the shaft is configured to be non-cutting.

The invention will now be described with reference to embodiments taken in conjunction with the drawing, in which:

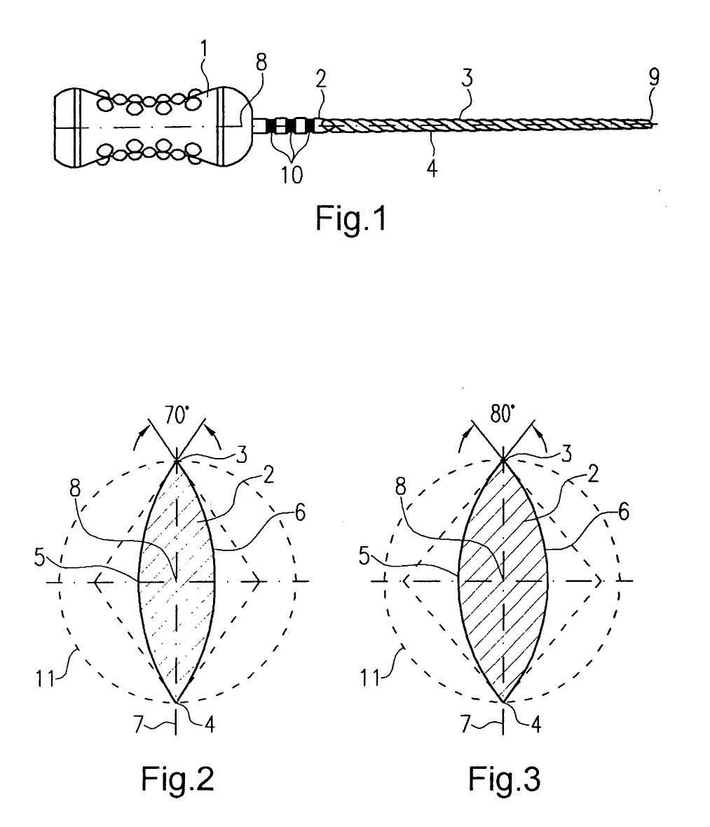

FIG. 1 is a schematic side view of a root canal instrument according to the invention;

FIG. 2 is a sectional view through the working part of the shaft according to a first design variant;

FIG. 3 is a sectional view, by analogy with FIG. 2, of a further design variant.

As shown in FIG. 1, the root canal instrument according to the invention comprises a grip member 1 having a shaft 2 attached thereto. Said shaft is in rotational symmetry with a longitudinal axis 8 with respect to its envelope. The portion of the shaft 2 adjoining the grip 1 may be made smooth and provided with marker rings 10.

A front portion 9 of the shaft 2 may be configured to be non-cutting whereas the remaining portion forming the working part of the shaft 2 is provided with two coiled or spiral cutting edges 3, 4.

Each of FIGS. 2 and 3 shows perpendicular sections relative to the longitudinal axis 8.

FIGS. 2 and 3 first of all show a circular envelope 11 which is obtained upon rotation of the root canal instrument about its longitudinal axis 8.

It follows from the cross-sectional shapes of FIGS. 2 and 3 that the shaft 2 is provided with two cutting edges 3, 4, each being positioned on the envelope 11. The two cutting edges 3, 4 are each interconnected by side surfaces 5, 6 that are made convex. Hence, this yields a lenticular or bird's tongue-like cross-section.

The two cutting edges 3, 4 are made identical with respect to one another. Furthermore, they are made symmetrical relative to a straight line 7 (straight central line) connecting the two cutting edges 3, 4. Strictly speaking, there is no central plane because the working portion of the shaft 2 is coiled.

Furthermore, FIGS. 2 and 3 show different tangent angles on the cutting edges 3, 4. The tangent angle according to FIG. 2 is 70° while the tangent angle according to FIG. 3 is 80°. It goes without saying that with a larger tangent angle the convexity, i.e. the width of the bird's tongue-like or lenticular cross-section, gets also greater. The tangent angle may be chosen in dependence upon the respective dimension of the root canal instrument, particularly the length and the diameter of the shaft 2.

As follows from the above description, the root canal instrument according to the invention can be produced at particularly low costs because only the two side surfaces 5, 6 have to be machined in a corresponding way to obtain the desired cross-sectional shape.

The invention is not limited to the illustrated embodiments. Rather, many alterations and modifications are possible within the scope of the invention.

What is claimed is:

1. A root canal instrument for manual use, comprising a grip member (1) which has attached thereto an elongated tapering shaft (2) which is provided with at least one cutting edge coiled in spiral form around the longitudinal axis (8) of said shaft (2), characterized in that said shaft (2) has a cross-sectional shape which is provided at two opposite sides with one cutting edge (3, 4) each and whose side surfaces (5, 6) connecting said cutting edges (3, 4) are each made convex.

2. The root canal instrument according to claim 1, characterized in that the tangent angle at said cutting edge (3, 4) is made to range between 70° and 110°.

3. The root canal instrument according to claim 1, characterized in that said cutting edge (3, 4) is made symmetrical relative to a straight line (7) or plane connecting said two cutting edges (3, 4).

4. The root canal instrument according to claim 1, characterized in that the two cutting edges (3, 4) are made identical.

5. The root canal instrument according to claim 1, characterized in that said two side surfaces (5, 6) are curved in the form of an arc.

6. The root canal instrument according to claim 5, characterized in that said two side surfaces (5, 6) are curved in the form of a circular arc.

7. The root canal instrument according to claim 1, characterized in that said two side surfaces (5, 6) are made symmetrical relative to said straight line (7) or plane connecting said cutting edges (5, 6).

8. The root canal instrument according to claim 1, characterized in that the front portion (9) of said shaft (2) is configured to be non-cutting.

9. The root canal instrument according to claim 2, characterized in that said cutting edge (3, 4) is made symmetrical relative to a straight line (7) or plane connecting said two cutting edges (3, 4).

10. The root canal instrument according to claim 2, characterized in that the two cutting edges (3, 4) are made identical.

11. The root canal instrument according to claim 3, characterized in that the two cutting edges (3, 4) are made identical.

12. The root canal instrument according to claim 2, characterized in that said two side surfaces (5, 6) are curved in the form of an arc.

13. The root canal instrument according to claim 3, characterized in that said two side surfaces (5, 6) are curved in the form of an arc.

14. The root canal instrument according to claim 4, characterized in that said two side surfaces (5, 6) are curved in the form of an arc.

15. The root canal instrument according to claim 2, characterized in that said two side surfaces (5, 6) are made symmetrical relative to said straight line (7) or plane connecting said cutting edges (5, 6).

16. The root canal instrument according to claim 3, characterized in that said two side surfaces (5, 6) are made symmetrical relative to said straight line (7) or plane connecting said cutting edges (5, 6).

17. The root canal instrument according to claim 4, characterized in that said two side surfaces (5, 6) are made symmetrical relative to said straight line (7) or plane connecting said cutting edges (5, 6).

18. The root canal instrument according to claim 5, characterized in that said two side surfaces (5, 6) are made symmetrical relative to said straight line (7) or plane connecting said cutting edges (5, 6).

19. The root canal instrument according to claim 6, characterized in that said two side surfaces (5, 6) are made symmetrical relative to said straight line (7) or plane connecting said cutting edges (5, 6).

20. The root canal instrument according to claim 2, characterized in that the front portion (9) of said shaft (2) is configured to be non-cutting.
